(19) United States
(12) Patent Application Publication
(10) Pub. No.: US 2013/0282593 A1
(43) Pub. Date: Oct. 24, 2013

(54) METHOD AND SYSTEM FOR GENERATING SAFETY ALERTS

(71) Applicants: Christopher John Merz, Wildwood, MO (US); Kimberly Ann Purcell, Wilton, CT (US); Douglas Wilbur Van Horn, Kirkwood, MO (US); Joshua Joseph Baron, Wildwood, MO (US); John Gioacchini, Brewster, NY (US); Maria Escobar, Maspeth, NY (US)

(72) Inventors: Christopher John Merz, Wildwood, MO (US); Kimberly Ann Purcell, Wilton, CT (US); Douglas Wilbur Van Horn, Kirkwood, MO (US); Joshua Joseph Baron, Wildwood, MO (US); John Gioacchini, Brewster, NY (US); Maria Escobar, Maspeth, NY (US)

(21) Appl. No.: 13/449,827

(22) Filed: Apr. 18, 2012

(51) Int. Cl. G06Q 10/00

(52) U.S. Cl. 705/303

(57) ABSTRACT

A method and system for generating alerts are provided. The system includes a data warehouse configured to receive, for a plurality of financial transactions each using a financial payment card between a merchant and a customer, unique personal account numbers associated with each financial payment card, a transaction reference identifier, and a merchant identifier. The data warehouse is further configured to retrieve historical multi-party payment card transaction information for each personal account number. The system also includes an enterprise marketing platform configured to receive customer safety alert registration information from at least one of a merchant point of sale device, a web interface, and a mobile interface, and a customer contact server configured to receive safety alert information and corresponding customer information and to contact each corresponding customer in response to a safety alert affecting the customer.

### BACKGROUND OF THE INVENTION

The field of the invention relates generally to communicating safety alerts and/or recalls relating to a product to consumers of the product, and more specifically, to a method and a system for an electronic and network-based safety alert notification system automatically notifies customers that have purchased the product using a financial transaction card.

In 2009, over 900 products were recalled in the United States alone. In categories from food to baby products to automobiles, recalls are growing and safety issues are the most common reason for these recalls. Although Americans in a December 2010 Consumer Reports survey felt it was important to know about product recalls, less than one quarter of respondents had ever researched a product they purchased to see if it was recalled and more than half said they rarely or never filled out the registration cards that come with some products. As a result, the most common source of information about a recall is the news.

Today, the burden lies entirely with consumers to stay aware of the hundreds of product recalls that don't make local or national news. Filling out and mailing registration forms is burdensome and not an option for many types of products. Subscribing to alerts from the government (recalls.gov) or Consumer Reports (clickcheckandprotect.gov) yields a high volume of alerts, most of which are not relevant to an individual consumer. At least some known services and apps have originated to address the problem, they all require regular involvement and upkeep on the part of consumers to register purchases.

### BRIEF DESCRIPTION OF THE INVENTION

In one embodiment, a safety alert notification system includes a data warehouse configured to receive, for a plurality of financial transactions each using a financial payment card between a merchant and a customer, unique personal account numbers associated with each financial payment card, a transaction reference identifier, and a merchant identifier. The data warehouse is further configured to retrieve historical multi-party payment card transaction information for each personal account number. The system also includes an enterprise marketing platform configured to receive customer safety alert registration information from at least one of a merchant point of sale device, a web interface, and a mobile interface, and a customer contact server configured to receive safety alert information and corresponding customer information and to contact each corresponding customer in response to a safety alert affecting the customer.

In another embodiment, a method of generating consumer safety alerts includes receiving by a financial card interchange a registration request for a safety alert service, receiving financial transaction beacons from a merchant relating to a purchase of a product from the merchant by a cardholder associated with the financial card interchange, the financial transaction beacon including financial transaction data and a beacon identification, receiving a beacon identification of one or more financial transaction beacons corresponding to a safety alert regarding a product associated with each of the financial transaction beacons, determining a cardholder identification using the received beacon identification and the received financial transaction data, and transmitting safety alert information to the identified cardholder.

In yet another embodiment, one or more non-transitory computer-readable storage media includes computer-executable instructions that when executed by at least one processor, the computer-executable instructions cause the processor to receive by a financial card interchange a registration request for a safety alert service, receive financial transaction beacons from a merchant relating to a purchase of a product from the merchant by a cardholder associated with the financial card interchange, the financial transaction beacon including financial transaction data and a beacon identification, receive a beacon identification of one or more financial transaction beacons corresponding to a safety alert regarding a product associated with each of the financial transaction beacons, determine a cardholder identification using the received beacon identification and the received financial transaction data, and transmit safety alert information to the identified cardholder.

### BRIEF DESCRIPTION OF THE DRAWINGS

FIGS. 1-9 show exemplary embodiments of the methods and systems described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary system including a plurality of computer devices in accordance with one example embodiment of the present invention.

FIG. 3 is an expanded block diagram of an exemplary embodiment of a server architecture of the system including the plurality of computer devices in accordance with one example embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 illustrates a data flow diagram of a safety alert system in accordance with an exemplary embodiment of the present invention.

FIG. 7 is a data flow diagram of a safety alert notification process in accordance with an exemplary embodiment of the present invention.

FIG. 8 is a block diagram illustrating a data flow during a purchase using a financial transaction card in accordance with an exemplary embodiment of the present invention.

FIG. 9 is a block diagram illustrating a data flow during an execution of a recall in accordance with an exemplary embodiment of the present invention.

### DETAILED DESCRIPTION OF THE INVENTION

Embodiments of the methods and systems described herein relate to creating safety alert notifications for consumers who register their financial transaction cards with the alert notification service with automatic alerts any time a previously purchased product is recalled, giving consumers an easy way to ensure they are aware of purchases that have been recalled.

The methods and systems described herein may be implemented using computer programming or engineering techniques including computer software, firmware, hardware or any combination or subset thereof, wherein the technical effect may include at least one of: (a) receiving by a financial card interchange a registration request for a safety alert service, (b) receiving financial transaction beacons from a merchant relating to a purchase of a product from the merchant by a cardholder associated with the financial card interchange, (c) receiving a beacon identification of one or more financial transaction beacons corresponding to a safety alert regarding a product associated with each of the financial transaction beacons, (d) determining a cardholder identification using the received beacon identification and the received financial transaction data, and (e) transmitting safety alert information to the identified cardholder.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

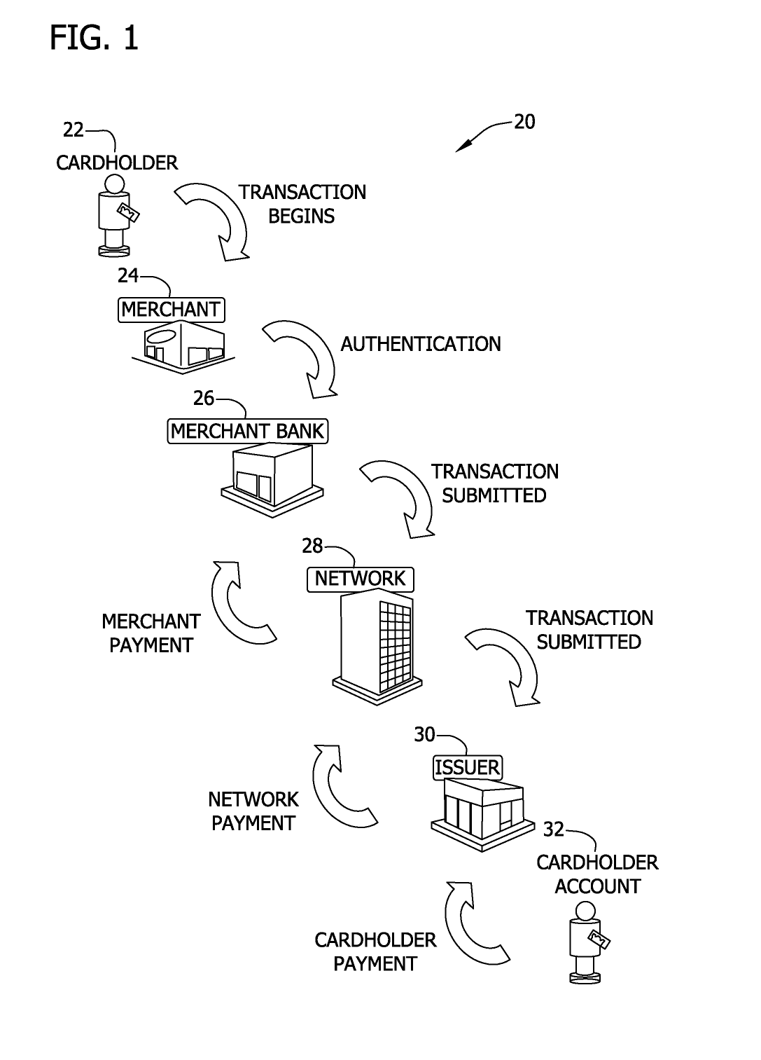

FIG. 1 is a schematic diagram illustrating an exemplary multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a financial card interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

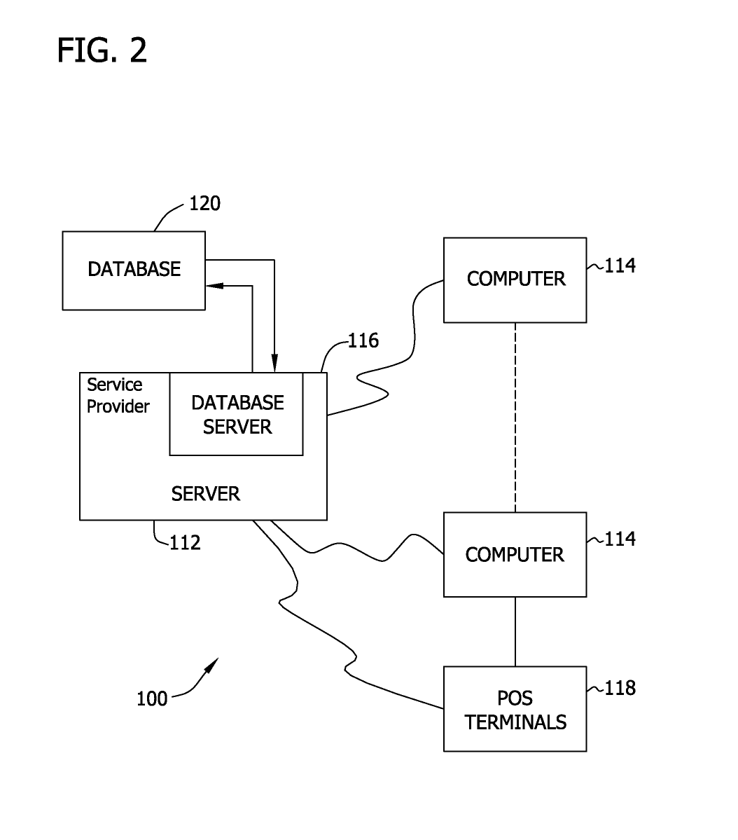

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an exemplary processing system 100 including a plurality of computer devices in accordance with one embodiment of the present invention. In the example embodiment, system 100 may be used for performing payment-by-card transactions and/or generating safety alert notifications for cardholder 22. For example, system 100 may store beacons received from merchants along with associated PANs for the transaction associated with the beacon. System 100 may also receive an indication of a safety alert from the merchants including affected beacons. System 100 also matches the beacons to respective PANs to determine cardholders' 22 contact information and notification preferences. The system then can notify cardholders 22 using the stored preferences.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store beacons received from merchants along with associated PANs or other consumer identifier for processing according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the exemplary embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, a biller, and/or a safety alert notification system. The price tracking system may be associated with interchange network 28 or with an outside third party in a contractual relationship with interchange network 28. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc. Additionally, such other devices may be used to register cardholder 22 for services using system 100 and for receiving notifications of safety alerts.

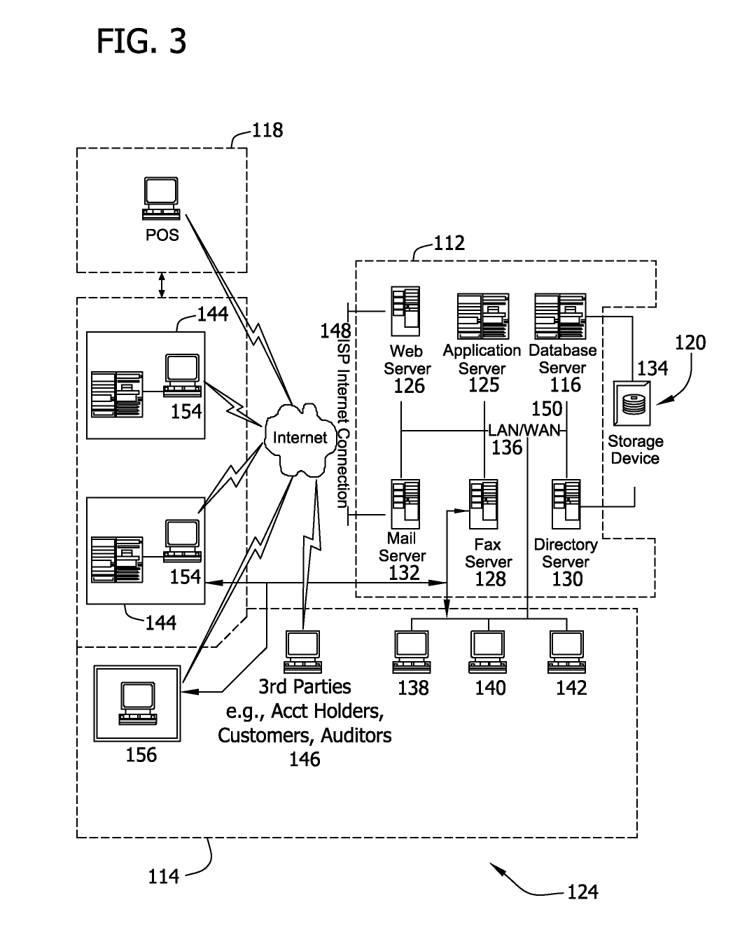

FIG. 3 is an expanded block diagram of an exemplary embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

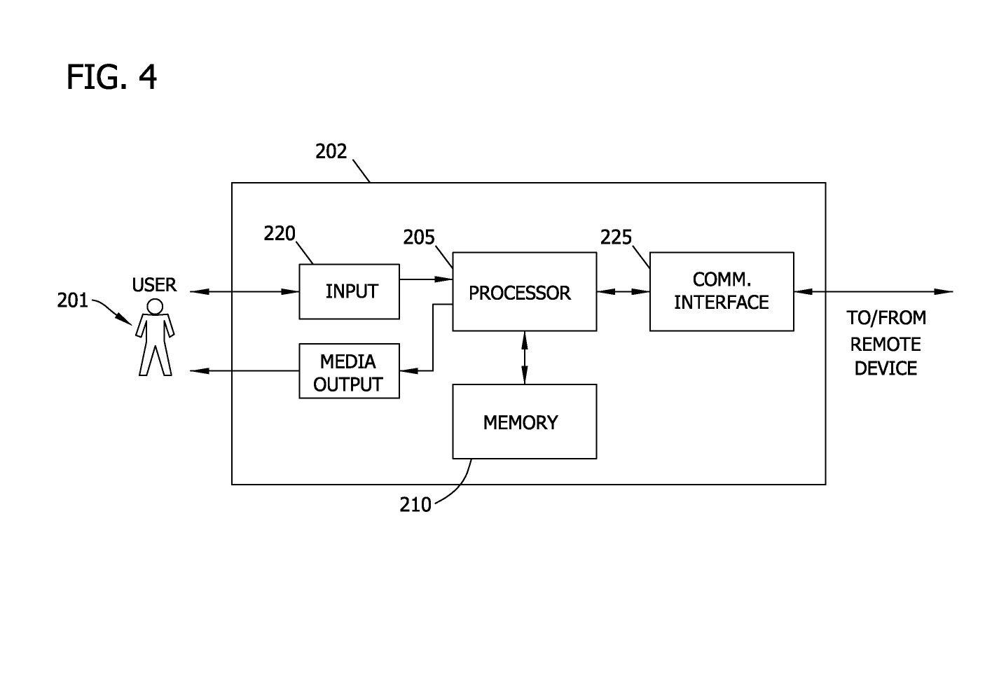

FIG. 4 illustrates an exemplary configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the exemplary embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

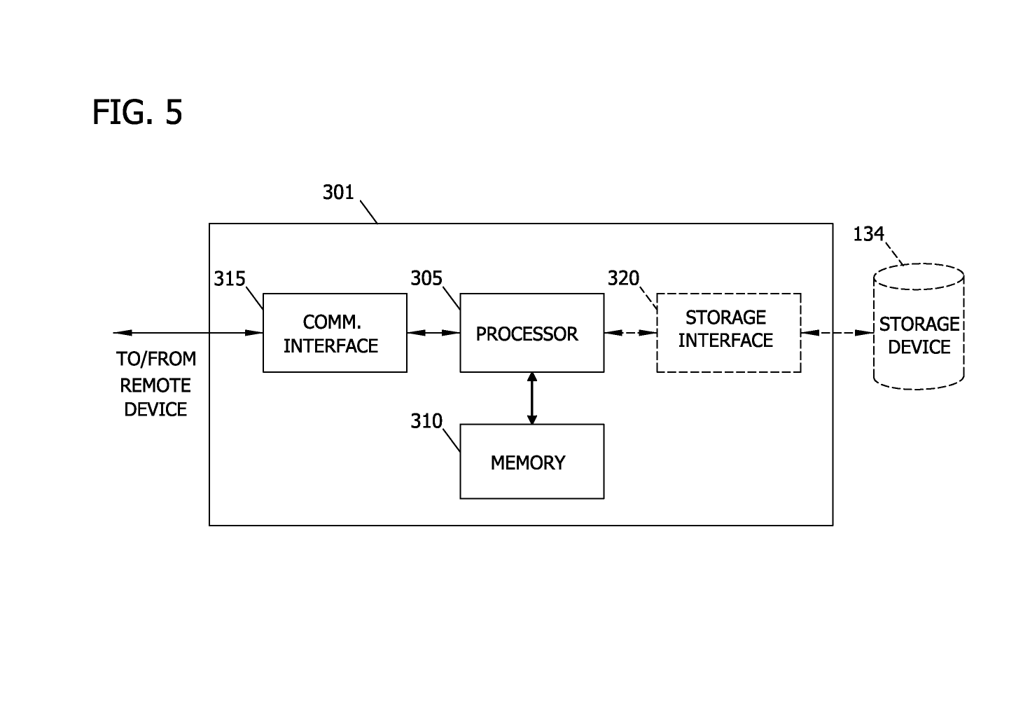

FIG. 5 illustrates an exemplary configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

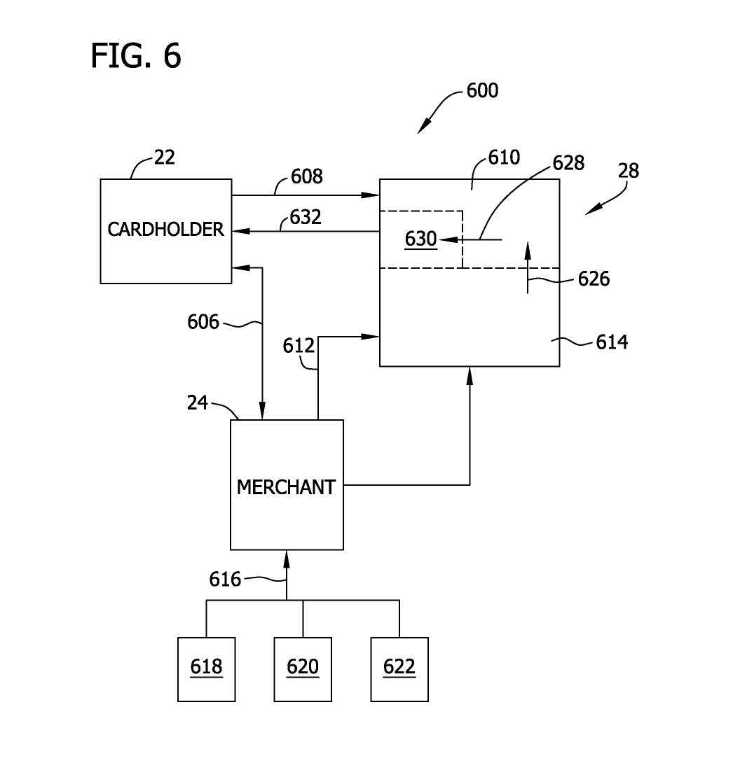

FIG. 6 illustrates a data flow diagram of a safety alert system 600 in accordance with an exemplary embodiment of the present invention. In the exemplary embodiment, a cardholder 22 initiates a purchase transaction with a merchant 24 wherein the cardholder presents a financial payment card, such as, but not limited to, a credit card, a debit card, or a gift card to the merchant for payment for a product. In various embodiments, the transaction may include a card-not-present (CNP) transaction. Transaction information 606 is passed between cardholder 22 and merchant 24 for approval of the transaction by the card issuer.

During the transaction, cardholder 22 may be prompted to register for a safety alert notification service. If cardholder 22 registers for the safety alert service, cardholder 22 passes registration information 608 to an enterprise marketing platform portion 610 of, for example, financial card interchange network 28. Alternatively, cardholder 22 may register for the safety alert notification service at any time before or after the transaction. As more and different cardholders 22 make purchases, merchant 24 associates each product purchased with a beacon or an identifier. In one embodiment, a stock-keeping unit number (SKU) of the product purchased is associated with a beacon generated by merchant 24. Merchant 24 transmits the beacon 612 to, for example, a data warehouse portion 614 of financial card interchange network 28, where the beacons are associated with financial transaction information, for example, but not limited to, a personal account number (PAN) of cardholder 22. Using beacons, each cardholder 22 is associated with similar products having the same SKU (or other product identifier) as other cardholders 22.

When a safety alert, for example, but not limited to, a recall of a product, is issued by a manufacturer 618, a government/regulatory agency 620, a third-party service 622, it is received by merchant 24. Merchant 24 associates the SKU of the product, which is the subject of the recall, with the previously assigned beacons and transmits 624 the beacons to data warehouse portion 614 of financial card interchange network 28. Data warehouse 614 performs a matching of the beacons to the associated PANs and transmits 626 the matching information to enterprise marketing platform portion 610. Enterprise marketing platform portion 610 manages the notification process and transmits 628 notification data to a customer contact server 630, which performs the notification 632 of the safety alert to cardholders 22 that used a financial payment card associated with financial card interchange network 28 to purchase the product being recalled.

In embodiments described herein, cardholders 22 are only alerted about recalls on products they have actually purchased. Cardholders 22 are able to choose the method by which they are to be notified via, for example, but not limited to, SMS, email, or push notifications to their phone and can customize which products they want to monitor for alerts. Upon registering, the safety alert notification service transmits past purchases made a financial card interchange network 28 associated with financial card interchange network 28 from merchant 24 to permit consumers to set alerts for purchases made months before initial signup. Moreover, cardholders 22 are able to create unique profiles via a mobile app or web portal for further customization. With the safety alert notification being supplied to consumers via their trusted financial payment card provided, they are more likely to trust and act on the safety alerts than they would with other potential safety alert providers.

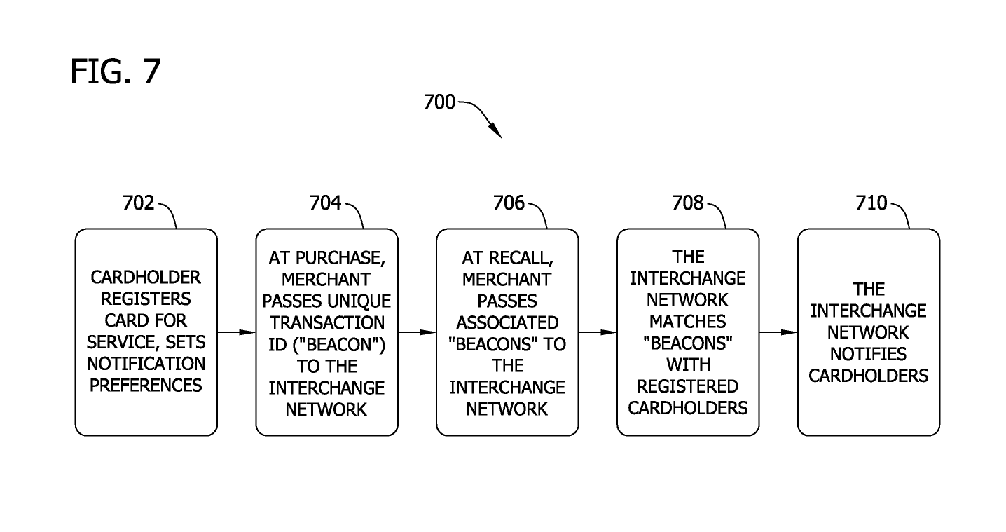

FIG. 7 is a data flow diagram of a safety alert notification process 700 in accordance with an exemplary embodiment of the present invention. In the exemplary embodiment, process 700 includes a registration step 702 wherein cardholders 22 register their associated financial payment card for the safety alert notification service and sets their notification preferences. Other preferences may also be set via a mobile device and/or web portal. Such preferences may be stored in a profile associated with cardholder 22. During a purchase transaction, merchant 24 collects various information from cardholder 22 and transmits a unique beacon associated with a transaction ID that identifies that particular transaction to financial card interchange network 28. In one embodiment, the purchase transaction information is transmitted to an enterprise marketing platform portion 610 (shown in FIG. 6) of financial card interchange network 28. After merchant 24 receives notice of a recall 706 of a particular product, merchant 24 transmits 706 beacons associated with the recalled product to financial card interchange network 28. Financial card interchange network 28 matches the beacons with the registered cardholders 22 and the respective cardholders 22 are notified 710 by financial card interchange network 28.

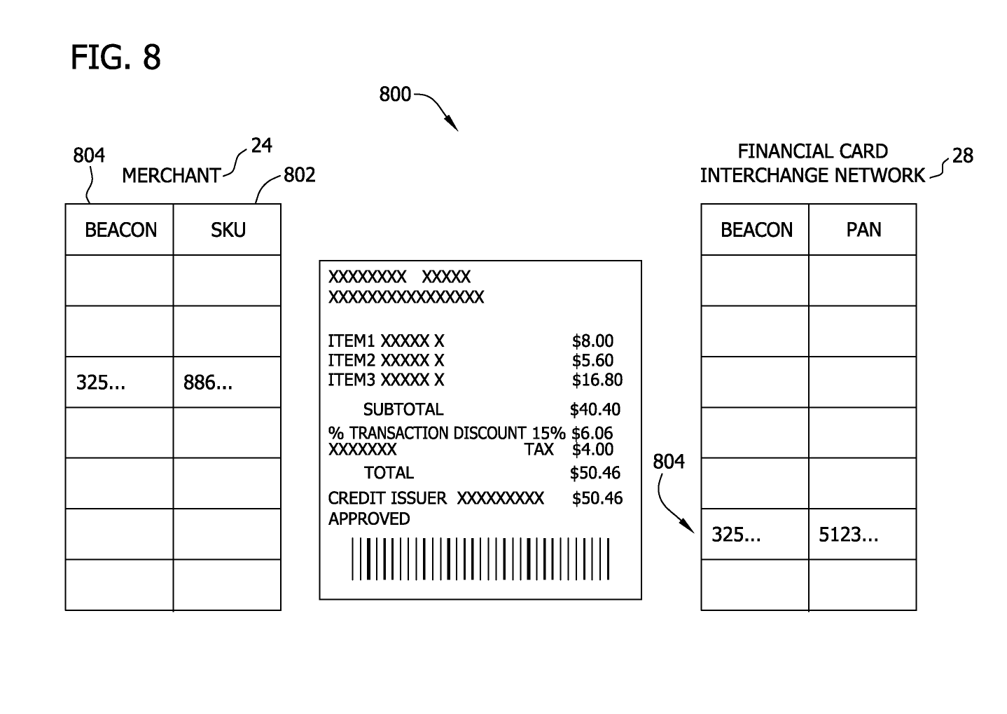

FIG. 8 is a block diagram 800 illustrating a data flow during a purchase using a financial transaction card in accordance with an exemplary embodiment of the present invention. In the exemplary embodiment, during a purchase transaction, merchant 24 collects various information from cardholder 22 and the items purchased, for example, but not limited to, a SKU number 802 associated with each item. Merchant 24 associates the SKU with a unique identifier called a “beacon” 804 and transmits the beacon to financial card interchange network 28, where financial card interchange network 28 associates beacon 804 with a PAN associated with the financial transaction card used in the purchase.

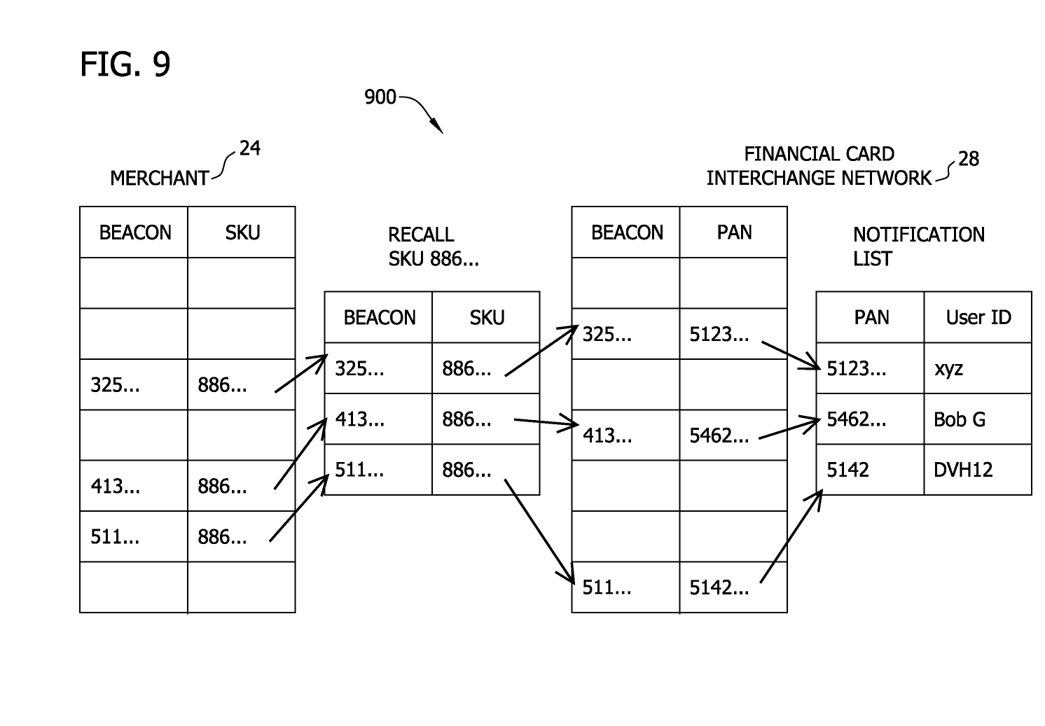

FIG. 9 is a block diagram 900 illustrating a data flow during an execution of a recall in accordance with an exemplary embodiment of the present invention. In the exemplary embodiment, during a recall of an item purchased using a financial card by cardholder 22 whom has registered with the safety alert notification system, merchant 24 receives a notice of recall from one or more of manufacturer 618, a government/regulatory agency 620, a third-party service 622 (all shown in FIG. 6). The recall notice identifies the item by the product identifier or SKU 802. Merchant retrieves all beacons 804 associated with the SKU 802 identifying the recalled item and transmits those SKUs 802 to financial card interchange network 28. Financial card interchange network 28 uses the transmitted beacons to retrieve the PANs associated with the beacons. Using the PANs, financial card interchange network 28 determines the cardholders 22 to be contacted regarding the recall.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, 305, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

The above-described embodiments of a method and system of generating safety alerts provides a cost-effective and reliable means for contacting consumers regarding safety alerts for products the consumer has actually purchased. More specifically, the methods and systems described herein facilitate maintaining a unique product identifier that associates products purchased to personal account numbers of the purchasers and therefore the purchaser identity and contact information. In addition, the above-described methods and systems facilitate contacting the purchaser regarding a safety alert affecting only those products the purchaser actually purchased. As a result, the methods and systems described herein facilitate providing relevant safety information to consumers in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A safety alert system comprising a financial card interchange network that includes:
a data warehouse comprising a database coupled to processor, said data warehouse configured to receive, from one or more merchants, for a plurality of financial transactions each using a financial payment card between a merchant and a customer:
unique personal account numbers associated with each financial payment card, and
a financial transaction beacon generated by the merchant that associates each customer with other customers that have purchased products having an identical product identifier,
said data warehouse further configured to:
match the received financial transaction beacon to an identity of all customers that have purchased products associated with the received financial transaction beacon using the unique personal account numbers, and
determine contact information for the identified customers using the identity;
an enterprise marketing platform configured to receive customer safety alert registration information from at least one of a merchant point of sale device, a web interface, and a mobile interface; and
a customer contact server configured to:
receive safety alert information from the one or more merchants and the determined contact information; and
contact each corresponding customer in response to a safety alert affecting the customer.

2. A system in accordance with claim 1, wherein the received customer safety alert registration information includes customer notification preference data and wherein the customer contact server is further configured to contact each corresponding customer using the received customer notification preference data.

3. A system in accordance with claim 2, wherein the received customer safety alert registration information includes customer notification preference data and wherein the customer contact server is further configured to contact each corresponding customer in response to a received safety alert for a product the customer has purchased.

4. A system in accordance with claim 3, wherein said data warehouse is configured to receive a financial transaction beacon from a merchant relating to a purchase of a product from the merchant by a cardholder associated with the financial card interchange network, the financial transaction beacon including financial transaction data and a beacon identification.

5. A system in accordance with claim 4, wherein said data warehouse is configured to receive a beacon identification of one or more financial transaction beacons corresponding to a safety alert regarding a product associated with each of the financial transaction beacons.

6. A system in accordance with claim 4, wherein said customer contact server is configured to determine a cardholder identity using the received beacon identification and transmit the determined cardholder identity to said enterprise marketing platform.

7. A system in accordance with claim 1, wherein said customer contact server is further configured to receive the cardholder identity and safety alert details associated with each received cardholder identity.

8. A method of generating consumer safety alerts, said method comprising:
receiving by an enterprise marketing platform of a financial card payment network, a registration request for a safety alert service;
receiving by a data warehouse comprising a database coupled to processor, a plurality of financial transaction beacons from a merchant, each of the plurality of financial transaction beacons relating to a purchase of a single product from the merchant by a cardholder associated with the financial card payment network, each of the financial transaction beacons including financial transaction data that identifies the single product and a beacon identification;
receiving by the data warehouse, a beacon identification associated with a product that is a subject of a product safety alert;
matching the received beacon identification to personal identifiers that associate the received beacon identification to an identity of one or more cardholders who purchased the product;
determining by a customer contact server of the financial card payment network, contact information of the cardholder using the personal identifier; and
transmitting safety alert information to the identified cardholder using the determined contact information.

9. A method in accordance with claim 8 further comprising receiving by the financial card payment network a safety alert service notification preference.

10. A method in accordance with claim 8 further comprising associating by the merchant a product identifier with each financial transaction beacon.

11. A method in accordance with claim 8 further comprising associating by the merchant a single product identifier with each financial transaction beacon.

12. A method in accordance with claim 8 wherein receiving at a financial card payment network a registration request for a safety alert service comprises receiving the registration request for the safety alert service from the cardholder.

13. A method in accordance with claim 8 wherein the safety alert is issued by a manufacturer of the product to the merchant.

14. A method in accordance with claim 8 wherein the financial transaction beacons include information relating a product identity to the financial transaction beacons.

15. A method in accordance with claim 8 wherein the financial transaction beacons include information relating a product stock-keeping unit (SKU) to the financial transaction beacons.

16. A method in accordance with claim 8 wherein transmitting safety alert information to the identified cardholder comprises transmitting safety alert information to the identified cardholder by the financial card payment network.

17. One or more non-transitory computer-readable storage media having computer-executable instructions embodied thereon, wherein when executed by at least one processor, the computer-executable instructions cause the processor to:
receive by a financial card interchange network a registration request for a safety alert service from a cardholder of the financial card interchange network;
receive a plurality of financial transaction beacons from a merchant, the financial transaction beacons generated by the merchant and each of the plurality of financial transaction beacons relating to a purchase of a single product from the merchant by a cardholder associated with the financial card interchange network, each of the financial transaction beacons including financial transaction data that identifies the single product and a beacon identification;
receive, from the merchant, a beacon identification associated with a product that is a subject of a product safety alert;
determine a cardholder identification using the received beacon identification and the received financial transaction data;
match the received beacon identification to personal identifiers that associate the received beacon identification to an identity of one or more cardholders who purchased the product;
determine contact information of the cardholder using the identity associated with personal identifier: and
transmit safety alert information to the identified cardholder using the contact information determined from the personal identifier.

18. The computer-readable storage media of claim 17, wherein the computer-executable instructions further cause the processor to receive by the financial card interchange network a safety alert service notification preference.

19. The computer-readable storage media of claim 17, wherein the computer-executable instructions further cause the processor to receive at a financial card interchange network a registration request for a safety alert service comprises receiving the registration request for the safety alert service from the cardholder.

20. The computer-readable storage media of claim 17, wherein the computer-executable instructions further cause the processor to transmit safety alert information to the identified cardholder by the financial card interchange network.
